(19) United States
(12) Patent Application Publication
(10) Pub. No.: US 2011/0068556 A1
(43) Pub. Date: Mar. 24, 2011

(54) Removable Container Apparatus For Use With Watercraft Trailer

(76) Inventor: Gordon Morgan, Corpus Christi, TX (US)

(21) Appl. No.: 12/562,912

(22) Filed: Sep. 18, 2009

(51) Int. Cl. B60P 3/42; B60P 3/10; B60P 3/00

(52) U.S. Cl. 280/414.1

(57) ABSTRACT

A transport system is provided for use on a watercraft trailer capable of being towed behind a motor vehicle. A removable container is provided having a base portion with a bottom wall and side walls defining an interior space. The container is attachable to the watercraft trailer frame and secured to structural members of the trailer, such as by adjustable straps extending between and through rings attached to the container and trailer frame. The container can be enclosed and include an upper portion which can be removably or pivotally attached to the base portion. Alternately, the container can have an access panel for allowing access to the interior of the container. The container can also have indentations in the bottom wall corresponding to structural members of the trailer.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### BACKGROUND OF THE INVENTION

The need to transport personal items such as luggage, camping equipment, machinery, etc., is a common occurrence. Many people have trailers for towing and transporting various watercraft, such as boats or personal watercraft, such as “jet-skis.” However, when these trailers are not being used to transport watercraft, such as in winter when the watercraft is in storage, the trailer often sits unused. Thus, there is a need to provide a removable storage container that can be positioned on and secured to a pre-existing watercraft trailer in order to transport objects to a desired location when the trailer is not being used to transport watercraft.

### SUMMARY OF THE INVENTION

A transport system is provided for use on a watercraft trailer capable of being towed behind a motor vehicle. A removable container is provided having a base portion with a bottom wall and side walls defining an interior space. The container is attachable to the watercraft trailer frame and secured to structural members of the trailer, such as by adjustable straps extending between and through rings attached to the container and trailer frame. The container can be enclosed and include an upper portion which can be removably or pivotally attached to the base portion. Alternately, the container can have an access panel for allowing access to the interior of the container. The container can also have indentations in the bottom wall corresponding to structural members of the trailer.

### BRIEF DESCRIPTION OF THE DRAWINGS

The accompanying drawing is incorporated into the specification to help illustrate examples according to the presently most-preferred embodiment of the inventions. The drawing is not to be construed as limiting the inventions.

FIG. 1 is a top-view of a trailer for transporting personal watercraft;

FIG. 2 is a side-view of a trailer for transporting personal watercraft;

FIG. 3 is a top-view of one embodiment of the container according to the invention;

FIG. 4 is a side-view of one embodiment of the container according to the invention;

FIG. 5 is a rear-view of one embodiment of the container according to the invention;

FIG. 6 is a cross-sectional partial view of a corrugated material for use in an embodiment of the container of the invention taken along line 6-6 in FIG. 4;

FIG. 7 is a detail view of a means for securing the front of the container to a winch located on a trailer;

FIG. 8 is a detail view of section 8 of FIG. 5 showing a means for securing the container to the trailer;

FIG. 9 is a top-view of one embodiment of the container according to the invention which also shows the structural members of the trailer;

FIG. 10 is a cross-sectional rear-view taken along line 10-10 of FIG. 9 showing the container positioned on the trailer;

FIG. 11 is a detail view as indicated on FIG. 10 of a container positioned on the trailer;

FIG. 12 is a side-view of the container showing one embodiment of the upper portion of the container in a closed position;

FIG. 13 is a partial side-view of the container showing one embodiment of the upper portion of the container in an opened position;

FIG. 14 is a side-view of the container showing another embodiment of the upper portion of the container in a closed position; and

FIG. 15 is a side-view of the container showing another embodiment of the upper portion of the container in a closed position.

### DETAILED DESCRIPTION OF PREFERRED EMBODIMENTS OF THE INVENTION

The container can be made of any durable (stiff) material. For example, the container can be made of metal such as steel or aluminum, or a hard plastic or other suitable material. Preferably, the container is made of a hard plastic such that the overall weight of the container is lightweight enough for one person to position the container onto the pre-existing trailer.

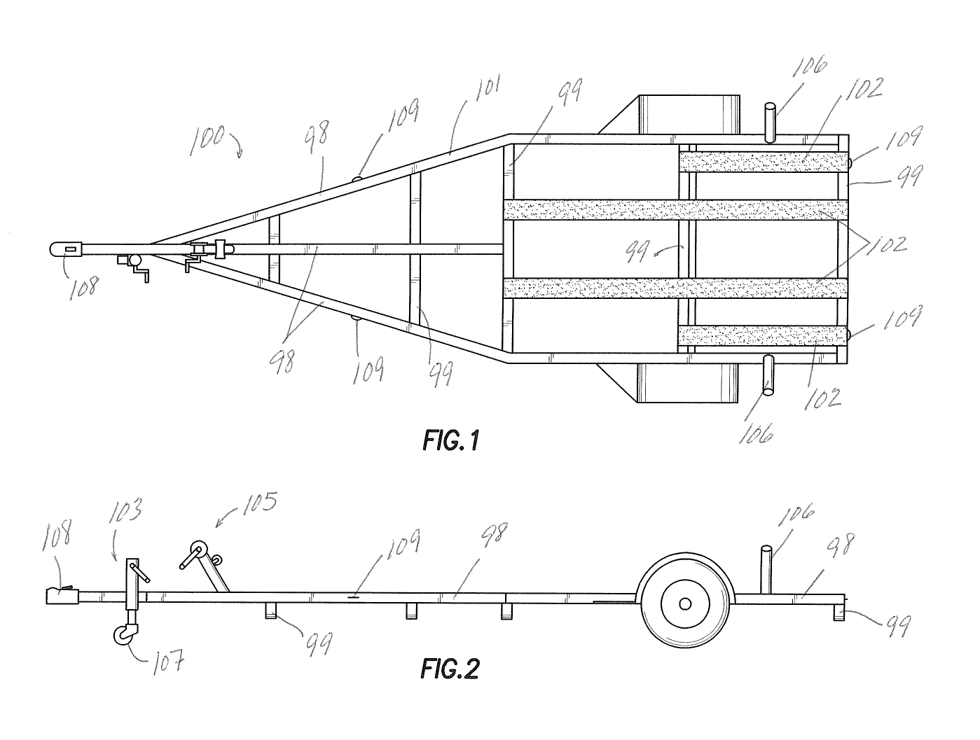

FIGS. 1 and 2 show an example of a trailer 100 used to hold or transport personal watercraft. The trailer 100 includes a frame 101. The frame 101 typically includes longitudinal members 98 and lateral members 99. It is common for some of the longitudinal members of the frame 101 to define a U-shape or V-shape where seen from an end view in order to accommodate the shape of the hull or underside of a watercraft. Attached to the frame 101 are support members 102 which provide support for the watercraft to sit on and also provide guides for the watercraft to stay aligned on the trailer when placing the watercraft on the trailer. Support members 102 are typically padded and positioned at an angle from the horizontal.

The front of the trailer 100 has a tongue that can be attached to a ball on the back of a vehicle for securing the trailer 100 to the vehicle. The front portion of the trailer 100 can have a height-adjustable front wheel assembly 103. The front wheel 107 of the assembly 103 is normally lowered to the ground via a handle, when the trailer 100 is not attached to a vehicle, in order to provide a level surface for the watercraft on the trailer 100. Once the trailer 100 has been attached to the back of a vehicle by trailer hitch 108, the front wheel 103 is raised such that it is no longer touching the ground. The trailer 100 also includes rear wheels 104 which allow the trailer 100 to be pulled behind a vehicle once attached to the vehicle. The front portion of the trailer 100 also includes a winch 105. The winch 105 is a means for loading the watercraft onto the trailer 100 as well as for securing the watercraft so it does not slip off the trailer 100 during transport. The winch 105 includes a ring for placing a rope or other like strap (which is attached to the front of the watercraft) through the ring, which can then be tied in any fashion to secure the watercraft to the winch 105. The winch 105 also includes a handle for reducing or creating slack in the rope or other like strap. The rear portion of the trailer 100 can also include one or more retaining bars 106 which provide lateral support for the watercraft, serves as a guide for the placement of the watercraft onto the trailer 100 when the trailer 100 is in the water, or prevents the watercraft from lateral displacement during transport. The trailer preferably also includes attachment structures 109, such as rings as shown, for securing the container assembly 200 to the trailer 100 by ropes, straps or the like, as explained further herein.

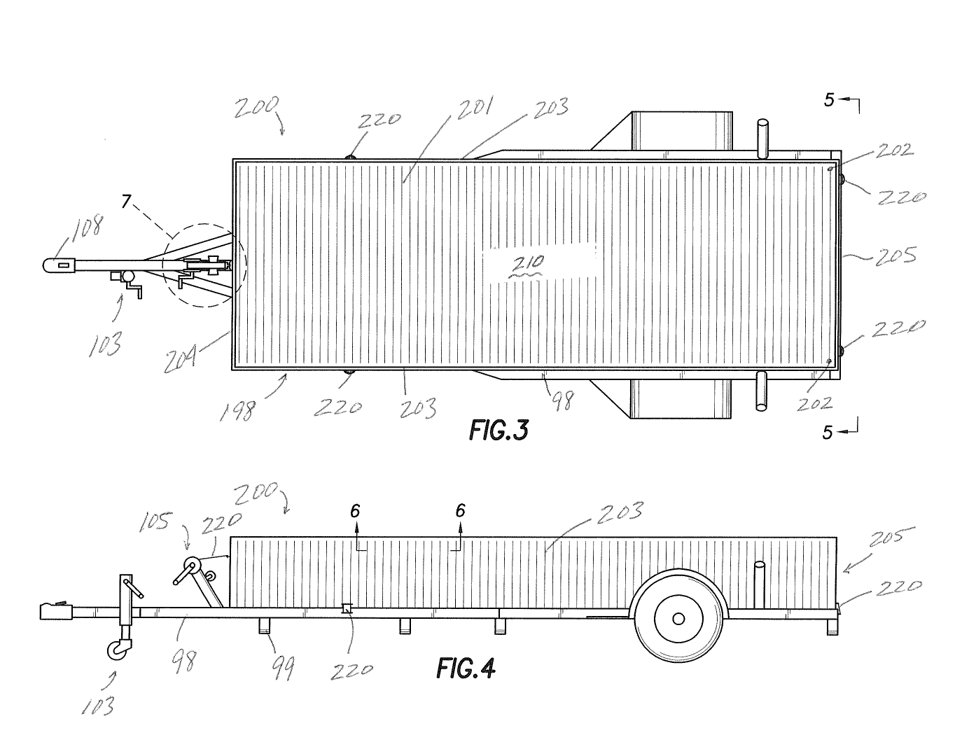

FIGS. 3 and 4 show one embodiment of the container 200 positioned on trailer 100. The container 200 has a base portion 198. The base portion 198 of the container 200 includes a bottom wall 201, side walls 203, front wall 204 and rear wall 205. The dimensions of the container 200 can vary as long as the container 200 is capable of fitting onto the frame 101 of the trailer 100. The bottom wall 201 can be square, rectangular or other shapes, or can be custom-molded to fit the specific shape of the frame 101. The bottom wall 201 can include drain holes 202 which allow liquids, such as rain water, to drain out of the bottom wall 201. The drain holes 202 can be located in the corners of the base portion 201 or elsewhere as desired. Preferably, the drain holes 202 are at the lowest area of the container 200 when in use on a trailer.

The base portion 198 of the container 200 also includes two side walls 203, a front wall 204, and a rear wall 205. The walls extend upwardly from and are attached to the bottom wall 201. The sides, front and rear walls are shown intersecting at right angles, however, the walls can intersect at any desired angle or arc. The container 200 can alternately have a pointed or circular front wall, be of other shape, or have rounded corners.

The container 200 is shown secured to the trailer 100 by attachment assemblies 220 at the container side wall 203, rear wall 205 and front wall 204 to the winch 205.

The bottom portion of the container 200 includes a rear wall 205 which can be attached to the bottom 201 by various means. In other embodiments, the rear wall 205 can be movably attached to the container such that it can be pivoted or “lowered” and “raised” to allow easier access to the interior space 210. For example, the rear wall 205 can be secured to the bottom wall 201 via hinges or other pivotal mounting. The hinges can be affixed to the bottom wall 201 and the rear wall 205 allowing the rear wall 205 to swing down towards the ground for opening. In this example, it is preferable that the side walls 203 and have a means for securing the rear wall 205 in a closed position. By way of another example, the hinges can attach one of the two side walls 203 and the rear wall 205. In this manner, the rear wall 205 can be swung outward from the container 200 parallel to the ground. In this example, it is preferable that the side wall 203 and rear wall 205 be fitted with a means for securing the rear wall in a closed position. In another embodiment, the rear wall 205 can be detachable from the bottom 201.

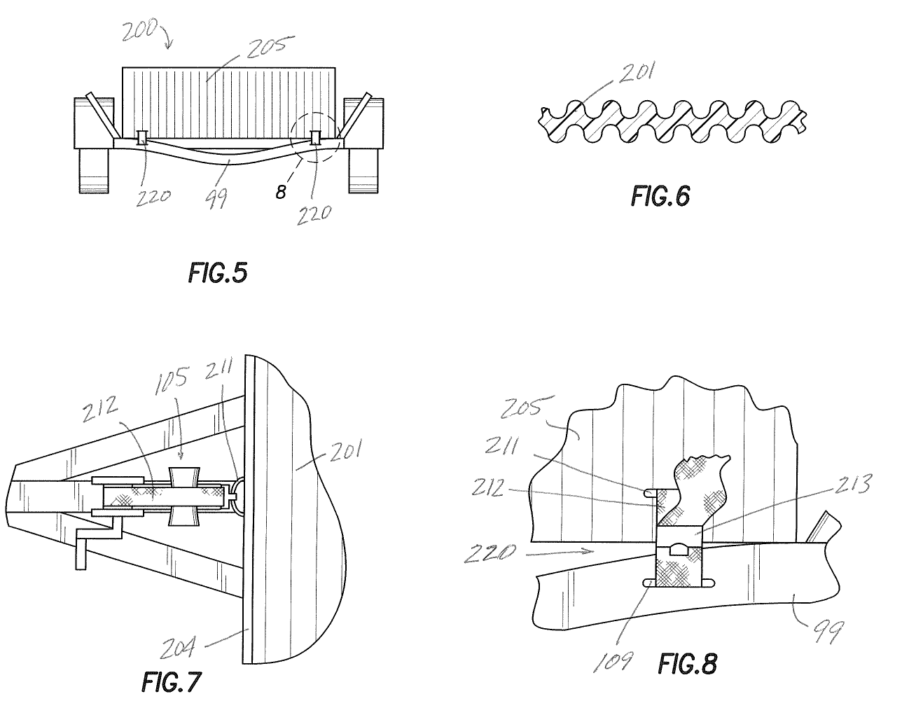

FIGS. 5 and 8 show attachment assemblies 220 for selectively securing the container 200 to the trailer 100. FIG. 8 is a detailed view of the means for securing seen in FIG. 5. FIG. 8 depicts exemplary rings 211, which need not be circular in shape, attached to the rear wall 205 and the trailer frame at lateral member 99. A strap (e.g., a nylon strap), tie-down, or other clamping mechanism 212 can be placed through both rings and then tied or clamped to secure the container 200 to rear wall 205 to the bottom wall 201. Rings 109 and 211 and strap 212 are exemplary. Alternate embodiments of attachment assemblies 220 for securing the container 200 to the trailer 100 can be used. Straps or tie-downs can be run through openings in the container wall, across the top of the container or through rings or hooks attached elsewhere on the container. Similarly, straps or tie-downs can be run around any structural member or other suitable member of the trailer. The term “rings” as used here means any mechanism creating a substantially closed loop, such as an opening in the container wall, a metal D-ring or O-ring attached to the container wall, or a recess in the container wall with a rod or pin extending across the recess. Other embodiments of attachment assemblies for securing the container includes latches, clips, clamps, protrusions extending from the container which engage structural members of the trailer, and other means known in the art. Since the container 200 is removable from the trailer, the attachment assemblies 220 are preferably readily and easily operated to secure and detach the container. Adjustable vinyl straps 212 with hand-operated clamps 213 are ideal.

FIG. 7 depicts an attachment assembly 220 for securing the base portion 198 of the container 200 to the winch 105 on the trailer 100. The front wall 204 of the container 200 includes a ring or hoop 211. The ring 211 allows a strap 212 or such to be fitted through the ring and attached to the winch 105 of the trailer 100. This allows the base portion of the container 200 to be secured to the trailer 100 in a manner similar to a watercraft being secured to the trailer 100. Alternately, the bottom wall, side wall or upper portion of the container can be used to attach to the winch strap or cable.

Preferably the container 200 can be attached to the trailer 100 using the winch assembly 105 in the same manner that watercraft is secured on the trailer. The container is designed to be lightweight and movable by a user or users. However, where desired or more practical, the container can be attached to the winch cable, which can then be cranked, moving the container onto the trailer.

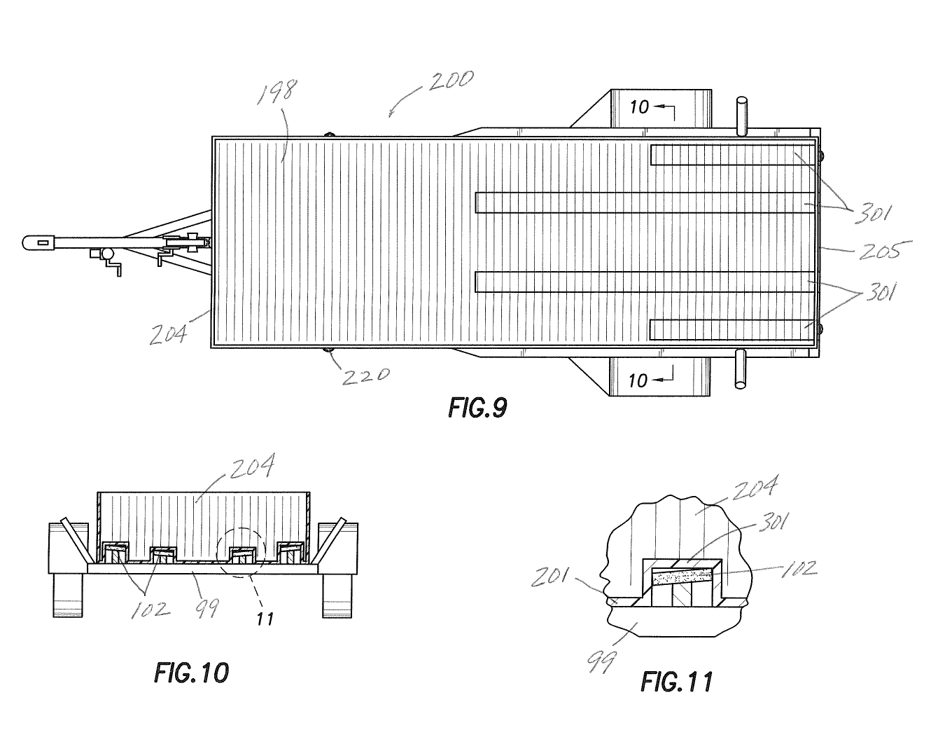

FIG. 9 is a top-view of the base portion 198 of the container 200 positioned on a trailer 100 showing indentations 301 in the bottom wall 201 of the container 200. FIG. 10 is a cross-sectional rear view of the indentations 301 of base portion of the container 200 in cooperation with the structural members 102 of the trailer 100 taken along line 10-10 of FIG. 9. FIG. 11 is a cross-sectional detail of FIG. 10 showing an indentation 301 in cooperation with a support member 102. The base portion 198 of the container 200 has indentations 301 formed to cooperate with the structural members 102. The indentations 301 are spaced and sized to accommodate the spacing and dimensions of the structural members 102 such that the bottom portion of the container 200 fits relatively flush with the frame of the trailer 101. The indentations 301 can be made to accommodate a variety of different trailers. The indentations 301 are shown extending longitudinally and only a portion of the length of the container. The indentations 301 can extend all or a portion of the length of the container, can extend longitudinally, laterally, diagonally or in any desired configuration.

The container 200 can include an upper portion 400. In one embodiment, the upper portion of the container 400 is simply a top wall 401 which can be permanently or semi-permanently attached to the base portion 198, for example, at side walls 203, front wall 204, and rear wall 205. The base and upper portions can be monolithic, that is, of a single piece, or can be separate pieces attached to one another by semi-permanent fasteners, such as nuts and bolts, screws and the like. Where the upper portion is removable, it can be attached to the base portion by latches, clips and the like.

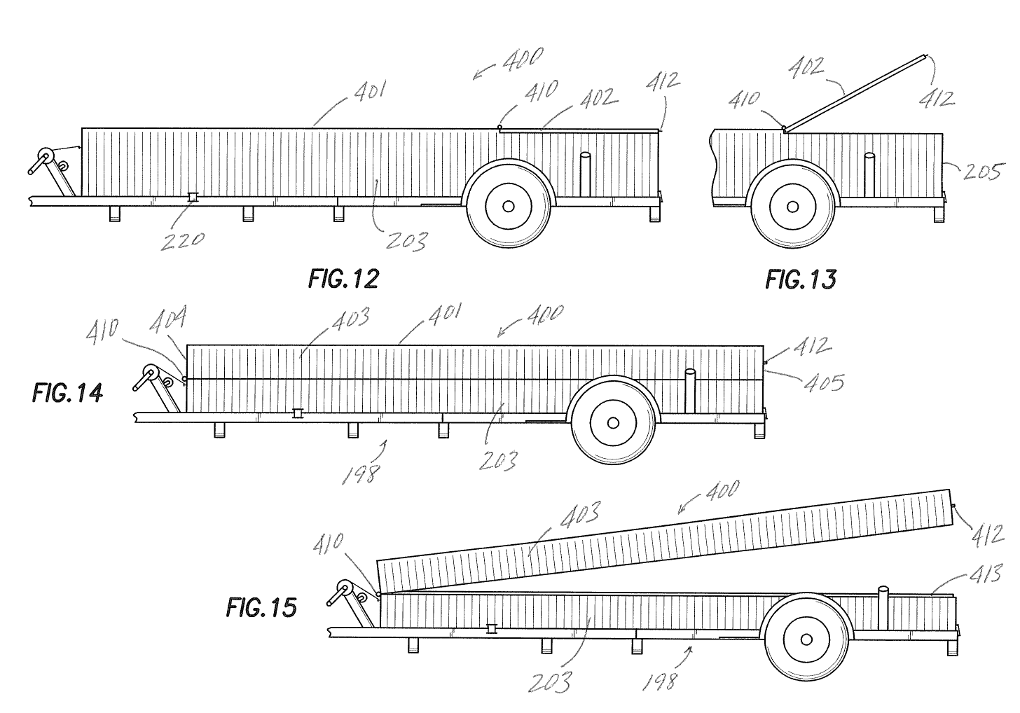

FIG. 12 shows an embodiment with the upper portion 400 having a access panel 402 (shown in a closed position) pivotally attached to the upper portion 400 via a pivotal connector. In this manner, the access panel 402 can be opened for access to the interior storage space and closed to protect stowed items. The access panel 402 can be removably attached to the container 200, such as with a plurality of latches, clips and the like. Alternately, the access panel 402 is pivotally attached to the container at a pivotal connector 410, such as by one or more hinges, pin and slot assemblies, a rod extending through openings in the access panel and container body, or other means known in the art. Preferably the access panel 402 rotates through an arc such that the access panel rests in an open position supported by other portions of the container. FIG. 13 is a cut-away of the rear portion of the container showing the access panel 402 in an open position.

The access panel 402 is shown in a preferred embodiment positioned at the top of the container and near the rear of the container. The access panel 402 can be located elsewhere on the container and multiple access panels can be used. For example, two access panels can be placed on either side of the container extending longitudinally, that is, with their pivotal attachments extending longitudinally along the container, parallel with the side walls. Further, the access panel 402 is shown as a generally planar panel in FIGS. 12 and 13. The access panel 402 can alternately be of other shape, such as generally L-shaped, having a generally horizontal portion which, when closed, is flush with the container top, and a generally vertical portion which, when closed, is flush with the container side wall. Other shapes and arrangements will be apparent to the practitioner.

According to another embodiment, as depicted in FIGS. 14 and 15, the upper portion 400 of the container has a top wall 401, side walls 403, a front wall 404, and a rear wall 405. In FIG. 14 the upper portion 400 of the container is shown in a closed-position. The upper portion 400 is attached to the base portion 198 of the container 200 via a pivotal connector 410 located at the front wall 404 of the upper portion 400 and front wall 204 of the base portion 198 of the container. FIG. 15 shows the upper portion of the container in an open position. The upper portion 400 and base portion 198 abut one another at lip 413 when in the closed position in an exemplary embodiment.

The upper portion 400 or access panel 402 of the container can have a spring mechanism (not shown), such as a gas or mechanical spring, to reduce the force required by the user to open the container. Additionally, the container can include a support mechanism (not shown), such as articulated arms, to support the upper portion 400 or access panel 402 and maintain it in an open position. The support mechanism preferably includes a locking mechanism to lock the upper portion or access panel in the open position. Preferably, the upper portion of the container has a means for securing 412 the upper portion in a closed-position. The means for securing 412 can be a lock, latch, clasp, clip, or any other suitable means.

The container can be made of any durable material. For example, the container can be made of metal, such as steel or aluminum, a hard plastic, rubber or other synthetic material, or a composite material such as fiberglass. Preferably, the container is made of a material such that the overall weight of the container is lightweight so it may be easily positioned on and removed from the trailer.

It is to be understood that numerous modifications, alterations, sub-combinations, and changes can be made in the invention without departing from the spirit and scope of the invention as set forth in the appended claims.

Having thus described the invention, we claim:

1. A transport system comprising:
a watercraft trailer for towing behind a motor vehicle, the watercraft trailer having a frame with structural members for supporting a watercraft;
a removable container having a base portion with a bottom wall and side walls defining an interior space, wherein the container is able to support and maintain items in the interior space; and
means for securing the container to at least one of the structural members of the watercraft trailer, the means for securing movable between a secured position wherein the container is securely attached to the trailer and a detached position wherein the container is detached from the trailer and able to be removed from the trailer.

2. The system of claim 1 wherein the container further comprises an upper portion attachable to the base portion.

3. The system of claim 2 wherein the upper portion is attached to the base portion pivotally and is movable between a closed position wherein the interior space of the container is substantially enclosed and an open position wherein the interior space of the container is substantially open.

4. The system of claim 1 wherein the container further comprises at least one indentation in at least one of the walls of the container, the indentation corresponding to at least one of the structural members of the trailer.

5. The system of claim 4 wherein the container comprises longitudinal indentations extending along the length of the bottom wall of the container, each of the indentations corresponding to structural members of the trailer.

6. The system of claim 1 wherein the container is of corrugated synthetic material.

7. The system of claim 1 wherein the side walls further includes a rear wall, and wherein the rear wall pivotally attached to the container and is movable between an open and a closed position.

8. The system of claim 7 further comprising a latch assembly mounted to the rear wall and another wall of the container, the latch for selectively securing the rear wall in the closed position.

9. The system of claim 1 wherein the container includes a top wall.

10. The system of claim 9 further comprising an access panel movable between an open and a closed position, the access panel allowing access to the interior space of the container when in the open position.

11. The system of claim 10 further comprising multiple access panels.

12. The system of claim 1 wherein the means for securing the container to at least one of the structural members of the trailer includes at least one ring attached to the container and an adjustable strap extending through the ring and around at least one structural member of the trailer.
